(19) United States
(12) Patent Application Publication
(10) Pub. No.: US 2014/0114650 A1
(43) Pub. Date: Apr. 24, 2014

(54) Method for Transforming Non-Stationary Signals Using a Dynamic Model

(71) Applicant: MITSUBISHI ELECTRIC RESEARCH LABS, INC., Cambridge, MA (US)

(72) Inventors: John R. Hershey, Winchester, MA (US); Cedric Fevotte, Paris (FR); Jonathan Le Roux, Somerville, MA (US)

(73) Assignee: Mitsubishi Electric Research Labs, Inc., Cambridge, MA (US)

(21) Appl. No.: 13/657,077

(22) Filed: Oct. 22, 2012

(51) Int. Cl. G10L 19/02

(52) U.S. Cl. 704/203; 704/E19.001

(57) ABSTRACT

An input signal, in the form of a sequence of feature vectors, is transformed to an output signal by first storing parameters of a model of the input signal in a memory. Using the vectors and the parameters, a sequence of vectors of hidden variables is inferred. There is at least one vector hₙ of hidden variables h_{i,n} for each feature vector xₙ, and each hidden variable is nonnegative. The output signal is generated using the feature vectors, the vectors of hidden variables, and the parameters. Each feature vector xₙ is dependent on at least one of the hidden variables h_{i,n} for the same n. The hidden variables are related according to

$${h}_{i , n} = {\sum }_{j , l}^{ } {c}_{i , j , l} {ɛ}_{l , n} {h}_{j , n - 1} ,$$

where j and l are summation indices. The parameters include non-negative weights c_{i,j,l}, and ε_{l,n} are independent non-negative random variables.

### FIELD OF THE INVENTION

This invention relates generally to signal processing, and more particularly to transforming an input signal to an output signal using a dynamic model, where the signal is an audio (speech) signal.

### BACKGROUND OF THE INVENTION

A common framework for modeling dynamics in non-stationary signals is a hidden Markov model (HMM) with temporal dynamics. The HMM is the de facto standard for speech recognition. A discrete-time HMM models a sequence of N observed (acquired) random variables

$$\{ {x}_{n} \} {=}^{def} {x}_{1 : N} {=}^{def} \{ {x}_{1} , {x}_{2} , … , {x}_{N} \} ,$$

i.e., signal samples, by conditioning probability distributions on the sequence of unobserved random state variables {hₙ}. Two constraints are typically defined on the HMM.

First, the state variables have first-order Markov dynamics. This means that p(hₙ|h_{l:n-1})=p(hₙ|hₙ₋₁), where the p(hₙ|hₙ₋₁) are known as transition probabilities. The transition probabilities are usually constrained to be time-invariant.

Second, each sample xₙ, given the corresponding state hₙ, is independent of all other hidden states h_{n′}, n′≠n, so that p(xₙ|h_{1:N})=p(xₙ|hₙ), where the p(xₙ|hₙ) are known as observation probabilities. In many speech applications, the states hₙ are discrete, and observations xₙ are F-dimensional vector-valued continuous acoustic features,

$${x}_{n} {=}^{def} \{ {x}_{f , ( n )} \} {=}^{def} \{ {x}_{1 n} , {x}_{2 n} , … , {x}_{Fn} \} ,$$

where the parentheses indicate that n is not iterated. Typical frequency features are short-time log power spectra, where f indicates a frequency bin.

Defining initial probabilities

$$p ( {h}_{1} \vert {h}_{0} ) {=}^{def} p ( {h}_{1} ) ,$$

the joint distribution of the random variables of the HMM is

$$p ( \{ {x}_{n} \} , \{ {h}_{n} \} ) = {\prod }_{n = 1}^{N} p ( {x}_{n} \vert {h}_{n} ) p ( {h}_{n} \vert {h}_{n - 1} ) . \qquad ( 1 )$$

Linear Dynamical Systems

A related model is a linear dynamical system used in Kalman filters. The linear dynamical system is characterized by states and observations that are continuous, vector-valued, and jointly Gaussian distributed

hₙ=Ahₙ₋₁+εₙ, (2)

vₙ=Bhₙ+vₙ, (3)

where hₙεR^{K} (or hₙεC^{K}) is the state at lime n, K the dimension of the state space, A is a state transition matrix, εₙ is additive Gaussian transition noise, vₙεR^{F} (or vₙεC^{F}) is the observation at time n, F is the dimension of the observation (or feature) space, B is an observation matrix, vₙ is additive Gaussian noise, and R is real.

Non-Negative Matrix Factorization

In the context of audio signal processing, the signal is typically processed using a sliding window and a feature vector representation that is often a magnitude or power spectrum of the audio signal. The features are nonnegative. In order to discover repeating patterns in the signal in an unsupervised way, nonnegative matrix factorization (NMF) is extensively used.

For a nonnegative matrix V of dimensions F×N, a rank-reduced approximation is

V≈WH,

where W and H are nonnegative matrices of dimensions F×K and K×N, respectively. The approximation is typically obtained from a minimization

$${min}_{W , H \geq 0} D ( V \vert WH ) = {\sum }_{fn}^{ } d ( {v}_{fn} \vert {[ WH ]}_{fn} ) ,$$

where d(x|y) is a positive function scalar cost function with a unique minimum at x=y.

Itakura-Saito Nonnegative Matrix Factorization (IS-NMF)

For the audio signal, where the matrix V is the power spectrogram of a complex-valued short-time Fourier transform (STFT) matrix X, conventional methods have used the Itakura-Saito distance, which measures the difference between the actual and approximated spectrum, as the cost function, because the cost function implies a latent model of superimposed zero-mean. Gaussian components that is relevant for audio signals. More precisely, let x_{fn} be the complex-valued STFT coefficient at frame n and frequency f, and

$${x}_{fn} = {\sum }_{k}^{ } {c}_{fkn} ,$$

### Where

c_{fkn}:N_{c}(0,w_{fk}hₖₙ).

Then,

$$\begin{matrix}- log p ( X \vert W , H ) = {\sum }_{fn}^{ } \frac{{v}_{fn}}{{\sum }_{k}^{ } {w}_{fk} {h}_{kn}} + log {\sum }_{k}^{ } {w}_{fk} {h}_{kn} \\ = {D}_{IS} ( {\vert X \vert}^{2} \vert WH ) + cst , ( 5 )\end{matrix} \\ where \\ {v}_{fn} = \vert {x}_{fn}^{2} \vert . \qquad ( 4 )$$

The model can also be expressed as

$${x}_{fn} \text{:} {N}_{c} ( 0 , {\sum }_{k}^{ } {w}_{fk} {h}_{kn} ) .$$

It is equivalent to assume that |x|_{fn}² is exponentially distributed with parameter Σₖw_{fk}hₖₙ and uniform phase

$$\begin{matrix}{\vert x \vert}_{fn}^{2} \text{:} Exponential ( {\sum }_{k}^{ } {w}_{fk} {h}_{kn} ) , & ( 6 ) \\ {∠x}_{fn} \text{:} Uniform ( - π , + π ) . & ( 7 )\end{matrix}$$

Smooth IS-NMF

In smooth variants of IS-NMF, an inverse-gamma or gamma random walk is assumed for independent rows of H. More precisely, the following model has been considered:

hₖₙ=hₖ₍ₙ₋₁₎∘εₖₙ,

where εₖₙ is nonnegative multiplicative innovation random variable with mode 1, such as

εₖₙ:G(α,α−1), or

εₖₙ:IG(α,α+1),

where by convention gamma and inverse-gamma are

$$\begin{matrix}G ( x \vert α , β ) = \frac{{β}^{α}}{Γ ( α )} {x}^{α - 1} exp - β x , \\ and & ( 8 ) \\ IG ( x \vert α , β ) = \frac{{β}^{α}}{Γ ( α )} {x}^{- ( α + 1 )} exp - \frac{β}{x} . & ( 9 )\end{matrix}$$

Models Combining HMMs and NMF

If HMMs and NMF are combined, then the restriction that only one discrete state can be active at a time is inherited from the HMMs. This means that multiple model are required for multiple source, leading to potential issues to computational tractability.

U.S. Pat. No. 7,047,047 describes denoising a speech signal using an estimate of a noise-reduced feature vector and a model of an acoustic environment. The model is based on a non-linear function that describes a relationship between the input feature vector, a clean feature vector, a noise feature vector and a phase relationship indicative of mixing of the clean feature vector and the noise feature vector.

U.S. Pat. No. 8,015,003 describes denoising a mixed signal, e.g., speech and noise, using a NMF constrained by a denoising model. The denoising model includes training basis matrices of a training acoustic signal and a training noise signal, and statistics of weights of the training basis matrices. A product of the weights of the basis matrix of the acoustic signal and the training basis matrices of the training acoustic signal and the training noise signal is used to reconstruct the acoustic signal.

In general, the prior art methods that focus on slow-changing noise, are inadequate for fast-changing nonstationary noise, such as experienced by using a mobile telephone in a noisy environment.

Although HMMs can handle speech dynamics, HMMs often lead to combinatorial issues due to the discrete state space, which is computationally complex, especially for mixed signals from several sources. In conventional HMM approaches it is also not straightforward to handle gain adaptation.

NMF solves both the computational and gain adaptation issues. However, NMF does not handle dynamic signals. Smooth IS-NMF attempts to handle dynamics. However, the independence assumption of the rows of H is not realistic, as the activation of a spectral pattern at frame n is likely to be correlated with the activation of other patterns at a previous frame n−1.

It is an object of the invention to solve inherent problems associated with signal and data processing using HMMs and NMF frameworks.

### SUMMARY OF THE INVENTION

It is an object of the invention to transform an input signal to an output signal when the input signal is a non-stationary signal, and more specifically a mixture of signals. Therefore, the embodiments of the invention provide a non-negative linear dynamical system model for processing the input signal, particularly a speech signal that is mixed with noise. In the context of speech separation and speech denoising, our model adapts to signal dynamics on-line, and achieves better performance than conventional methods.

Conventional models for signal dynamics frequently use hidden Markov models (HMMs) or non-negative matrix factorization (NMF).

HMMs lead to combinatorial problems due to the discrete state space, are computationally complex, especially for mixed signals from several sources. In conventional HMM approaches it is also not straightforward to handle gain adaptation.

NMF solves both the computational complexity and gain adaptation problems. However, NMF does not take advantage of past observations of a signal to model future observations of that signal. For signals with predictable dynamics, this is likely to be suboptimal.

Our model has advantages of both the HMMs and the NMF. The model is characterized by a continuous non-negative state space. Gain adaptation is automatically handled during inference. The complexity of the inference is linear in the number of signal sources, and dynamics are modeled via a linear transition matrix.

Specifically the input signal, in the form of a sequence of feature vectors, is transformed to the output signal by first storing parameters of a model of the input signal in a memory.

Using the vectors and the parameters, a sequence of vectors of hidden variables is inferred. There is at least one vector hₙ of hidden variables h_{i,n} for each feature vector xₙ, and each hidden variable is nonnegative.

The output signal is generated using the feature vectors, the vectors of hidden variables, and the parameters. Each feature vector Xₙ is dependent on at least one of the hidden variables h_{i,n} or the same n. The hidden variables are related according to

$${h}_{i , n} = {\sum }_{j , l}^{ } {c}_{i , j , l} {ɛ}_{l , n} {h}_{j , n - 1 ,}$$

where j and l are summation indices. The parameters include non-negative weights c_{i,j,l}, and ε_{l,n} are independent non-negative random variables.

### BRIEF DESCRIPTION OF THE DRAWINGS

FIG. 1 is a flow diagram for transforming an input signal to an output signal;

FIG. 2 is a flow diagram of a method for determining parameters of a dynamic model according to embodiment of the invention; and

FIG. 3 is a flow diagram of a method for enhancing a speech signal using the dynamic model according to embodiments of the invention.

### DETAILED DESCRIPTION OF THE PREFERRED EMBODIMENT

### Introduction

The embodiments of our provide a model for transforming and processing dynamic (non-stationary) signal and data that has advantages of HMMs and NMF based models.

The model is characterized by a continuous non-negative state space. Gain adaptation is automatically handled on-line during inference. Dynamics of the signal are modeled using a linear transition matrix A. The model is a non-negative linear dynamical system with multiplicative non-negative innovation random variables εₙ. The signal can be a non-stationary linear signal, such as an audio or speech signal, or a multi-dimensional signal. The signal can be expressed in the digital domain as data. The innovation random variable is described in greater detail below.

The embodiments also provide applications for using the model. Specifically, the model can be used to process an audio signal acquired from several, sources, e.g., the signal is a mixture of speech and noise (or other acoustic interference) and the model is used to enhance the signal by, e.g., reducing noise. When we say “mixed,” we mean that the speech and noise are acquired by a single sensor (microphone).

However, it is understood that the model can also be used for other non-stationary signals and data that have characteristics that vary over time, such as economic or financial data, network data and signals, or signals, medical signals, or other signals acquired from natural phenomena. The parameters include non-negative weights c_{i,j,l}, and ε_{l,n} are independent non-negative random variables, the distributions of which also have parameters. The indices i,j,l, and n are described below.

General Method

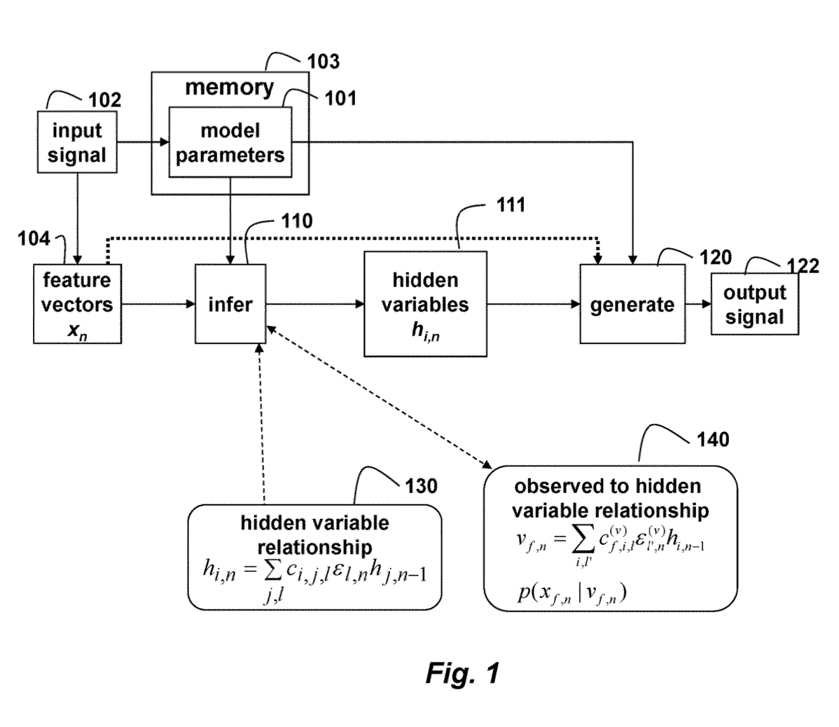

As shown in FIG. 1, parameters 101 of a model of an input signal 102 are stored in a memory 103.

The input signal is received as a feature vectors xₙ 104 of salient characteristics of the signal. The features are of course application and signal specific. For example, if the signal is an audio signal, the features can be log power spectra. It is understood that the different type of features that can be used is essentially unlimited for many types of different signals and data that can be processed by the method according to the invention.

The method infers 110 a sequence of vectors of hidden variables 111. The inference is based on the feature vector 104, the parameters, a hidden variable relationship 130, and a relationship 140 of observations to hidden variables. There is at least one vector hₙ of hidden variables h_{i,n} for each feature vector xₙ. Each hidden variable is nonnegative.

An output signal 122 corresponding to the input signal is generated 120 to form the feature vectors, the vectors of hidden variables, and the parameters.

General Method Details

In our method, each feature vector xₙ is dependent on at least one of the hidden variables h_{i,n} for the same n. The hidden variables are related according to a hidden variable relationship

$${h}_{i , n} = {\sum }_{j , l}^{ } {c}_{i , j , l} {ɛ}_{l , n} {h}_{j , n - 1} \qquad$$

130, where j and l are summation indices. The stored parameters include non-negative weights c_{i,j,l}, and ε_{l,n} are independent non-negative random variables. This formulation enables the model to represent statistical dependency over time in a structured way, so that the hidden variables for the current frame, n, are dependent on those of the previous frame, n−1 with a distribution that is determined by the combination of c_{i,j,l}, and the parameters of the distribution of the weights ε_{l,n}. The weight ε_{l,n}, for example, may be Gamma random variables with shape parameter α and inverse scale parameter β.

In one embodiment, c_{i,j,l}=δ(i,l)a_{i,j}, where a_{i,j} are non-negative scalars, so that

$${h}_{i , n} = ( {\sum }_{j}^{ } {a}_{i , j} {h}_{j , n - 1} ) {ɛ}_{i , n} ,$$

where δ is a Kronecker delta. In this case, if the weights ε_{l,n}, are Gamma random variables with shape parameter α and inverse scale parameter β, then the conditional distribution of h_{i,n} given {h_{j,n-1}}ⱼ₌₁^{K}, where K is a number of elements in the hidden states vector, is

$$p ( {h}_{i , n} \vert {h}_{j , n - 1} ) = Gamma ( {h}_{i , n} \vert α , \frac{β}{{\sum }_{j}^{ } {a}_{i , j} {h}_{j , n - 1}} ) ,$$

where

$$Gamma ( x \vert a , b ) = \frac{{b}^{a}}{Γ ( a )} {x}^{a - 1} {e}^{- bx}$$

is the gamma distribution for random variable x with shape a, inverse scale b, and

$$Γ ( z ) = {\int }_{0}^{∞} {e}^{- {t}_{t} z - 1} d t$$

is the gamma function. This embodiment is designed to conform to the simplicity of the basic structure of a conventional linear dynamical system, but differs from prior art by the non-negative structure of the model, and the multiplicative innovation random variables.

In another embodiment, c_{i,j,l}=α(m(i,j),l),a_{i,j}, where a_{i,j} are non-negative scalars, δ is the Kronecker delta, δ(a,b)={_{0: otherwise}^{1: if a=b}, and m(i,j) is a one-to-one mapping from each combination of i and j to an index corresponding to l, (e.g., m(i,j)=(i−1)K+j, where K is a number of elements in the hidden variable hₙ) so that

$${h}_{i , n} = {\sum }_{j} {a}_{i , j} {ɛ}_{m} ( i , j ) , {n}^{h} j , n - 1.$$

This embodiment enables flexibility in modeling the signal, because each transition, can be inferred independently.

Another embodiment that is important to modeling multiple sources comprises partitioning hidden variables h_{i,n} into S groups, where each group corresponds to one independent source in a mixture. Likewise, the non-negative random variables ε_{l,n} are partitioned according to the same S groups. This can be accomplished by a special case of the parameters c_{i,j,l} where c_{i,j,l}=0 when h_{i,n}, and h_{j,n} are not in the same group or when h_{i,n} and ε_{l,n} are not associated with the same group. When the hidden variables are ordered accordingly, this gives c_{i,j,l} block structure, where each block corresponds to the model for one of the signal sources.

In our embodiments, the hidden variables are related 140 to feature variables via a non-negative feature v_{f,n}, of the signal indexed by feature f and frame n. An observation model is based on

$${v}_{f , n} = {\sum }_{j} {c}_{f , i , l}^{( v )} {h}_{i , n} {ɛ}_{l , n}^{( v )} ,$$

where c_{f,i,l}^{(v)} is a non-negative scalar, and ε_{l,n}^{(v)} are independent non-negative random variables, and j, and l are indices of different components.

In a more constrained embodiment c_{f,i,l}^{(v)}=δ(i,l)w_{f,i}, where w_{f,i} are non-negative scalars, where δ is the Kronecker delta, and ε_{f,n}^{(v)} are the Gamma distributed random variables, so that the observation model based, at least in part, on

$$p ( {v}_{f , n} \vert {h}_{n} ) = Gamma ( {v}_{f , n} \vert {α}^{( v )} , {β}^{( v )} / {\sum }_{i} {w}_{f , i} {h}_{i , n} ) ,$$

where v_{f,n} is non-negative feature of the signal at frame n and frequency f, α^{(v)} and β^{(v)} are positive scalars, and w_{f,i} are non-negative scalars.

In applications where the features x_{f,n} are complex spectrogram values of the input signal, a frame n and frequency f, the observation model can use v_{f,n}=|x_{f,n}|², which is the power in frame n, and frequency f. Thus, an observation model can be formed based on

$${x}_{f , n} = ( {e}^{{θ}_{f , n} \sqrt{- 1}} ) \sqrt{{v}_{f , n}} ,$$

where \sqrt{−1} is the unit imaginary number, and θ_{f,n}=∠x_{f,n} is a phase for a frame n and frequency f.

In another embodiment, we select the parameter α^{(v)}=1, so that the gamma distribution reduces to an exponential distribution as a special case. In this case, if the phases θ_{f,n} are distributed uniformly, then we obtain the observation model

$$p ( {x}_{f , n} \vert {h}_{n} ) = {N}_{c} ( 0 , {\sum }_{i} {w}_{f , i} {h}_{i , n} ) ,$$

where N_{C} is a complex Gaussian distribution. This observation model corresponds to the Itakura-Saito nonnegative matrix factorization described above, and is combined in our embodiments with the non-negative dynamical system model.

Another embodiment uses an observation model for v_{f,n} based on a cascade of transformations of the same type:

$${u}_{{i}^{′} , n} = {\sum }_{i} {c}_{{i}^{′} , i , l}^{( u )} {h}_{i , n} {ɛ}_{{l}^{′} , n}^{( u )} , \\ and$$

$${v}_{f , n} = {\sum }_{{i}^{′}} {c}_{f , {i}^{′} , l}^{( v )} {u}_{{i}^{′} , n} {ɛ}_{{l}^{″} , n}^{( v )} ,$$

where c_{i′,i,l′}^{(u)} and c_{f,i′,l″}^{(v)} are non-negative scalars, and ε_{l′,n}^{(u)} and ε_{l″,n}^{(v)} are independent non-negative random variables, and i, i′, l′, l″ are indices.

The method for inferring the hidden variables depends on the model parameterization for each embodiment.

Model Parameters

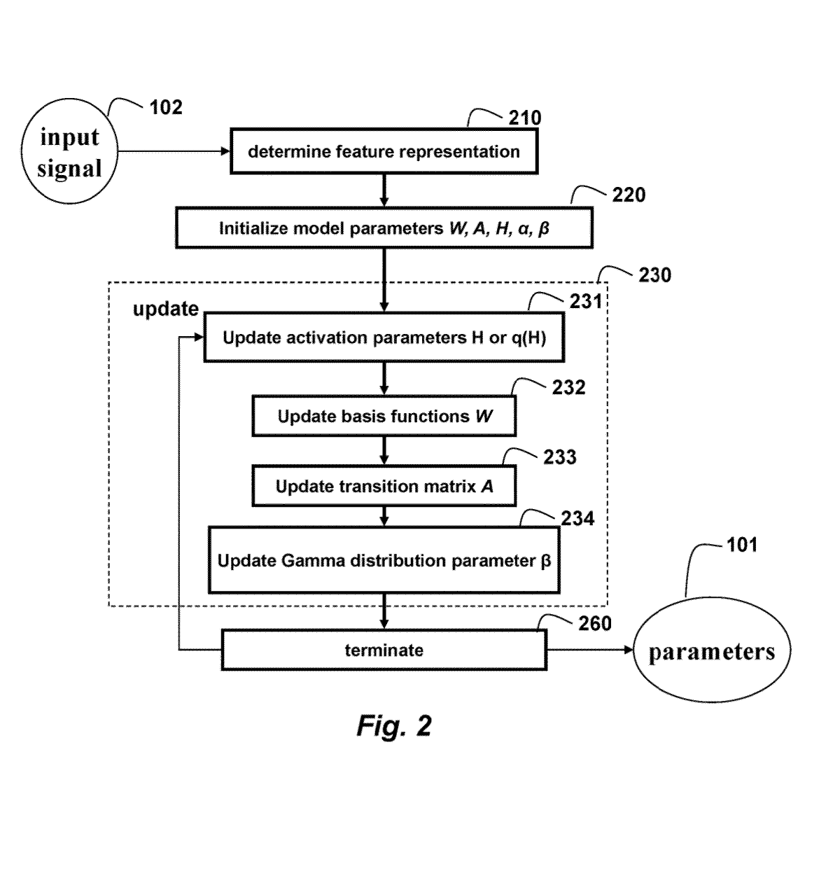

As shown in FIG. 2, from the input signal 102, we obtain the model parameters 101 as follows. The input signal can be considered a training signal, although it should be understood that the method can be adaptive to the signal, and “learn” the parameters on-line. The input signal can also be in the form of a digital signal or data.

For example, the training signal is a speech signal, or a mixed signal from multiple acoustic sources, perhaps including non-stationary noise, or other acoustic interference. The signal is processed as frames of signal samples. The sampling rate and number of samples in each frame is application specific. It is noted that the updating 230 described below for processing the current frame n is dependent on a previous frame n−1. For each frame we determine 210 a feature vector xₙ representation. For an audio input signal, frequency features such as log power spectra could be used.

Parameters of the model are initialized 220. The parameters can include basis functions W, a transition matrix A, activation matrix H, and a fixed shape parameter ca and an inverse scale parameter β of a continuous gamma distribution parameter, and various combinations of these parameters depending on the particular application. For example in some applications, updating H and β are optional. In a variational Bayes (VB) method, H is not used. Instead an estimate of the posterior distribution of H is used and updated. If a maximum a-posteriori (MAP) estimation, then updating β is optional.

During each iteration of the method, the activation matrix, the basis function, the transition matrix, and the gamma parameter are updated 231-134. It should again be noted that the set of parameters to be updated is also application specific.

A termination condition 260, e.g., convergence or a maximum number of iterations, is tested after the updating 230. If true, store the parameters in a memory, otherwise if false, repeat at step 230.

The above steps of the general method and the parameter determination can be performed in a processor connected to a memory and input/output interfaces as know. Specialized microprocessors, and the like can also be used. It is understood that the signals processed by the method, e.g., speech or financial data, can be extremely complex. The method transforms the input signal into features which can be stored in the memory. The method also stores the model parameters and inferred hidden variables in the memory.

Model Parameters Details

For simplicity of this description, we limit the notation to the embodiment where c_{f,i,l}^{(v)}=δ(i,l)w_{f,i}, the w_{f,i} are non-negative scalars δ is a Kronecker delta, and ε_{f,n}^{(v)} are gamma distributed random variables, with parameter α^{(v)}=1, and phases θ_{f,n} are distributed uniformly. In this case, our model is

$$\begin{matrix}{x}_{fn} : {N}_{c} ( 0 , {\sum }_{k} {w}_{fk} {h}_{kn} ) , & ( 10 ) \\ {h}_{n} = ( {Ah}_{n - 1} ) ∘ {ɛ}_{n} , & ( 11 )\end{matrix}$$

where x_{fn} is the complex-valued STFT coefficient at frame n and frequency f, N_{C} is the complex Gaussian distribution, w_{fk} is the value of the k^{th} basis function for the power spectrum at frequency f, hₙ and hₙ₋₁ are the n^{th} and the (n−1)^{th} columns of the activation matrix H, respectively, A is the nonnegative K×K transition matrix that models the correlations between the different patterns in successive frames n−1 and n, εₙ is a nonnegative innovation random variable, e.g., a vector of dimension K, and ∘ denotes entry-wise multiplication. The smooth IS-NMF can be obtained as a particular case of our model by setting A=I_{K}, where I_{K} is the K×K identity matrix.

### ADVANTAGES

A distinctive and advantageous property of our model is that more than one state dimension can be non-zero at a given time. This means that a signal simultaneously acquired from multiple sources by a single sensor can analyzed using a single model, unlike the prior art HMM which requires multiple models.

Gamma Model of Innovations

We use an independent gamma distribution for the innovation εₖₙ, namely

p(εᵢₙ|α,β)=G(αᵢ,βᵢ).

It follows that hₙ is conditionally gamma distributed, such that

$$p ( {h}_{n} \vert {Ah}_{n - 1} ) = {\prod }_{i} G ( {h}_{in} \vert {α}_{i} , {β}_{i} / {[ {Ah}_{n - 1} ]}_{i} ) ,$$

and in particular

$$E ( {h}_{in} \vert {Ah}_{n - 1} ) = \frac{{α}_{i}}{{β}_{i}} {\sum }_{j} {a}_{ij} {h}_{j ( n - 1 )} . \qquad ( 12 )$$

For h₁, we use an independent scale-invariant noninformative Jeffreys prior i.e.,

$$p ( {h}_{1} ) = {\prod }_{k} p ( {h}_{k 1} ) .$$

In Bayesian probability, the Jeffreys prior is a non-informative (objective) prior distribution on a parameter space that is proportional to the square root of the determinant of Fisher information.

MAP Inference in the Gamma Innovation Model

The maximum a-posteriori (MAP) objective function is

$$C ( W , H , A , β ) = {\sum }_{fn} ( \frac{{v}_{fn}}{{\sum }_{k} {w}_{fk} {h}_{kn}} + log {\sum }_{k} {w}_{fk} {h}_{kn} ) + {\sum }_{i = 1}^{K} {\sum }_{n = 2}^{N} ( {α}_{i} log {\sum }_{j} {a}_{ij} {h}_{j ( n - 1 )} + {β}_{i} \frac{{h}_{in}}{{\sum }_{j} {a}_{ij} {h}_{j ( n - 1 )}} + ( 1 - {α}_{i} ) log {h}_{in} ) + ( N - 1 ) {\sum }_{i} ( log Γ ( {α}_{i} ) - {α}_{i} log {β}_{i} ) - {\sum }_{i} log p ( {h}_{i 1} )$$

Scales

Scale-Ambiguity Between A and β

A K×K nonnegative diagonal matrix with coefficients λᵢ on its diagonal is Λ, thus,

C(W,H,ΛA,Λβ)=C(W,H,A,β),

which has a scale-ambiguity between A and β. When both A and β are estimated, the scale-ambiguity can be corrected in a number of ways, for example by fixing β to arbitrary values or by normalizing the rows of A at every iteration 230 and rescaling β accordingly. For example, we can normalize the rows of the transition matrix A such that the rows sum to 1, or so that the maximum coefficient in every row is 1. In some embodiments, βᵢ=αᵢ, i.e., the model expectation of the innovation random variable is 1.

Ill-Posedness of MAP

The scales of W and H are related by

$$C ( W {Λ}^{- 1} , Λ H , A , β ) = C ( W , H , {Λ}^{- 1} A Λ , β ) + N {\sum }_{i} log {λ}_{i} ,$$

where λᵢ is the i-th element of the diagonal of Λ.

Without further constraints, the minimization of the MAP objective leads to a degenerate solution such that ∥W∥→∞ and ∥H∥→0. If we assume that all the diagonal elements of Λ are equal, such that Λ=λI_{K}, then

C(WΛ⁻¹,ΛH,A)=C(W,H,A)+KN log λ.

The MAP objective can be made arbitrarily small by decreasing the value of λ. Hence, the norm of W is controlled during optimization. This can be achieved by hard or soft constraints. The hard constraint is a regular constraint that must be satisfied, and the soft constraint is a cost functions expressing a preference.

Hard Constraint

We solve

minC(W,H,A)s·t W≧0,H≧0,∥|wₖ∥_{|1}=1

using the change of variable W̅=WΛ⁻¹, H̅=ΛH with Λ=diag[λ₁, . . . , λ_{K}], and λₖ=PwₖP₁, the norm-constraint can be relaxed by solving

minC( W̅, H̅,A)=D_{IS}(V|WH)+S(ΛH)s·t W≧0,H≧0.

Soft Constraint (Penalization)

Another way we can control the norm of W is to add an appropriate penalty to the objective function, e.g.,

minC(W,H,A)+λ∥W∥₁s·t W≧0,H≧0

The soft constraint is typically simpler to implement than the hard constraint, but requires the tuning of λ.

Learning and Inference Procedures for MAP Estimation

We describe a majorization-minimization (MM) procedure. The MM is an iterative optimization procedure that can be applied to a convex objective function to determine maximums. That is, MM is a way to construct the objective function. MM determines a surrogate function that majorizes the objective function by driving the function to a local optimum. In our embodiments, the matrices H, A, and W are updated conditionally on one and another. In the following, tildes (~) denote current parameter iterations.

Inequalities

For {φₖ} such that Σₖφₖ=1, we have

$$\frac{1}{{\sum }_{k} {x}_{k}} \leq {\sum }_{k} \frac{{φ}_{k}^{2}}{{x}_{k}} ,$$

by Jensen s inequality. We can form an upper bound on log α by linearization, at any point φ,

$$log a \leq log φ + \frac{\partial log a}{\partial a} ( a - φ ) = ( log φ - 1 ) + \frac{a}{φ} .$$

In particular,

$$log {\sum }_{k} {a}_{k} {x}_{k} \leq ( log {\sum }_{k} {a}_{k} {\tilde{x}}_{k} - 1 ) + \frac{1}{{\sum }_{j} {a}_{j} {\tilde{x}}_{j}} {\sum }_{k} {a}_{k} {x}_{k} , \\ and$$

$$\frac{1}{{\sum }_{k} {a}_{k} {x}_{k}} \leq \frac{1}{{( {\sum }_{j} {a}_{j} {\tilde{x}}_{j} )}^{2}} {\sum }_{k} {a}_{k} \frac{{\tilde{x}}_{k}^{2}}{{x}_{k}} .$$

Fit to Data

$${D}_{IS} ( V \vert WH ) \leq {\sum }_{kn} ( {\tilde{p}}_{kn} \frac{{\tilde{h}}_{kn}^{2}}{{h}_{kn}} + {\tilde{q}}_{kn} {h}_{kn} )$$

$${\tilde{p}}_{kn} = {\sum }_{f} {w}_{fk} \frac{{v}_{fn}}{{\tilde{v}}_{fn}^{2}}$$

$${\tilde{q}}_{kn} = {\sum }_{f} \frac{{w}_{fk}}{{\tilde{v}}_{fn}}$$

$${\tilde{v}}_{fn} = {[ W \tilde{H} ]}_{fn}$$

$${D}_{IS} ( V \vert WH ) \leq {\sum }_{fk} ( {\tilde{p}}_{fk} \frac{{\tilde{w}}_{fk}^{2}}{{w}_{fk}} + {\tilde{q}}_{fk} {w}_{fk} )$$

$${\tilde{p}}_{fk} = {\sum }_{n} {h}_{kn} \frac{{v}_{fn}}{{\tilde{v}}_{fn}^{2}}$$

$${\tilde{q}}_{fk} = {\sum }_{n} \frac{{h}_{kn}}{{\tilde{v}}_{fn}}$$

$${\tilde{v}}_{fn} = {[ \tilde{W} H ]}_{fn}$$

Penalty Terms

$$Let {g}_{i n} = {\sum }_{j} {a}_{ij} {h}_{j ( n - 1 )} . \\ Then , log ( {g}_{i ( n + 1 )} ) \leq log ( {\tilde{g}}_{i ( n + 1 )} ) + \frac{1}{{\tilde{g}}_{i ( n + 1 )}} {\sum }_{j} {a}_{ij} ( {h}_{jn} - {\tilde{h}}_{jn} )$$

$$log ( {g}_{i ( n + 1 )} ) \leq log ( {\tilde{g}}_{i ( n + 1 )} ) + \frac{1}{{\tilde{g}}_{i ( n + 1 )}} {\sum }_{j} {h}_{jn} ( {a}_{ij} - {\tilde{a}}_{ij} )$$

$$\frac{1}{{g}_{i ( n + 1 )}} \leq \frac{1}{{\tilde{g}}_{i ( n + 1 )}^{2}} {\sum }_{j} {a}_{ij} \frac{{\tilde{h}}_{jn}^{2}}{{h}_{jn}}$$

$$\frac{1}{{g}_{i ( n + 1 )}} \leq \frac{1}{{\tilde{g}}_{i ( n + 1 )}^{2}} {\sum }_{j} {h}_{jn} \frac{{\tilde{a}}_{ij}^{2}}{{a}_{ij}}$$

$$( {\tilde{g}}_{i n} is either {\sum }_{j} {a}_{ij} {\tilde{h}}_{j ( n - 1 )} or {\sum }_{j} {\tilde{a}}_{ij} {h}_{j ( n - 1 )} )$$

Update Rules

The MM framework includes majorizing the terms of the objective function with the previous inequalities, providing an upper bound of the objective function that is tight at the current parameters, and minimizing the upper bound instead of the original objective. This strategy applied to the minimization of the MAP objective with the soft constraint on the norm of W leads to the following updates 230 as shown in FIG. 2.

Update 231 Activation Matrix H

The columns of H are updated 231 sequentially. Left to right updates makes the update hₙ⁽¹⁾ of hₙ at iteration l dependent of hₙ₋₁^{(l)} and hₙ₊₁^{(l-1)}. The update of hₖₙ involves rooting a polynomial of order 2, such that

$${h}_{kn} = \frac{\sqrt{{b}^{2} - 4 ac} - b}{2 a}$$

where the values of a, b, c are given in the next table.

n = 1

| | |
|---|---|
| a | ${\tilde{q}}_{kn} + {Σ}_{i} {α}_{i} \frac{{a}_{ik}}{{\tilde{g}}_{i ( n + 1 )}}$ |
| b | 1 (Jeffreys) or 0 (uniform) |
| c | $- {\tilde{h}}_{kn}^{2} ( {\tilde{p}}_{kn} + {Σ}_{i} {β}_{i} \frac{{a}_{ik} {h}_{i ( n + 1 )}}{{\tilde{g}}_{i ( n + 1 )}^{2}} )$ |

1 < n < N

| | |
|---|---|
| a | ${\tilde{q}}_{kn} + {Σ}_{i} {α}_{i} \frac{{a}_{ik}}{{\tilde{g}}_{i ( n + 1 )}} + \frac{{β}_{k}}{{g}_{kn}}$ |
| b | 1 − αₖ |
| c | $- {\tilde{h}}_{kn}^{2} ( {\tilde{p}}_{kn} + {Σ}_{i} {β}_{i} \frac{{a}_{ik} {h}_{i ( n + 1 )}}{{\tilde{g}}_{i ( n + 1 )}^{2}} )$ |

n = N

| | |
|---|---|
| a | ${\tilde{q}}_{kn} + \frac{{β}_{k}}{{g}_{kn}}$ |
| b | 1 − αₖ |
| c | −\tilde{h}ₖₙ² \tilde{p}ₖₙ |

In particular, for the exponential innovation with expectation 1 (αᵢ=βᵢ=1), we obtain the following multiplicative updates:

$$For n = 1 , \\ {h}_{kn} = {\tilde{h}}_{kn} \sqrt{\frac{{\tilde{p}}_{kn} + {\sum }_{i} \frac{{a}_{ik} {h}_{i ( n + 1 )}}{{\tilde{g}}_{i ( n + 1 )}^{2}}}{{\tilde{q}}_{kn} + {\sum }_{i} \frac{{a}_{ik}}{{\tilde{g}}_{i ( n + 1 )}} + \frac{1}{{\tilde{h}}_{kn}}}} . \\ For 1 < n < N , \\ {h}_{kn} = {\tilde{h}}_{kn} \sqrt{\frac{{\tilde{p}}_{kn} + {\sum }_{i} \frac{{a}_{ik} {h}_{i ( n + 1 )}}{{\tilde{g}}_{i ( n + 1 )}^{2}}}{{\tilde{q}}_{kn} + {\sum }_{i} \frac{{a}_{ik}}{{\tilde{g}}_{i ( n + 1 )}} + \frac{1}{{g}_{kn}}}}$$

$$For n = N , \\ {h}_{kn} = {\tilde{h}}_{kn} \sqrt{\frac{{\tilde{p}}_{kn}}{{\tilde{q}}_{kn} + \frac{1}{{g}_{kn}}}} .$$

Update 232 Basis Function W

$${w}_{fk} = {\tilde{w}}_{fk} \sqrt{\frac{{\tilde{p}}_{fk}}{{\tilde{q}}_{fk} + {λ}_{W}}}$$

Update 233 Transition Matrix A

$${a}_{ij} = {\tilde{a}}_{ij} \sqrt{\frac{{β}_{i} {\sum }_{n = 2}^{N} \frac{{h}_{i n} {h}_{j ( n - 1 )}}{{g}_{i n}^{2}}}{{α}_{i} {\sum }_{n = 2}^{N} \frac{{h}_{j ( n - 1 )}}{{\tilde{g}}_{i n}} + {λ}_{A}}}$$

Variational EM Procedure for Maximum Likelihood Estimation

The activation parameter H is a latent variable to integrate from the joint likelihood. For generality, we assume the gamma distribution parameters β={βᵢ} to be free. The shape parameters αᵢ are treated as fixed parameters. We minimize

C(W,A,β)=−log p(V|W,A,β)=−log∫_{H}p(V|W,H)p(H|A,β)dH.

This yields a better posed estimation problem because the set of parameters is of fixed-dimensionality w.r.t to the number of samples N. Furthermore, the objective is now better posed in terms of scales. For any positive diagonal matrix Λ, we have

C(W,A,β)=C(WΛ⁻¹,ΛAΛ⁻¹,β)

so that the renormalization of solution W* only induces a renormalization of A*. This is not true for the MAP approach.

For minimizing C(W,A,β), the EM procedure can be based on the complete dataset (V,H), and on the iterative minimization of

Q(θ|\tilde{θ})=−∫_{H} log p(V,H|W)p(H|V,\tilde{θ})dH,

where θ={W,A,β}. We do not use the posterior probability p(H|V,θ). Instead, we use a variational EM procedure. For any probability density function q(H), the following inequality holds:

C(θ)≦− [symbol] log p(V|WH) [symbol] _{q}− [symbol] log p(H|A) [symbol] _{q}+ [symbol] log q(H) [symbol] _{q}=B_{q}(θ),

where [symbol] • [symbol] _{q} denotes the expectation under q(H). Variational EM minimizes B_{q}(θ), instead of C(θ). At each iteration, the bound is first evaluated and tightened, given W and A by minimizing B_{q}(θ) over q, or more precisely, over the shape parameters of q, given a specific parameterized form, and then minimized with respect to (θ) given q. Variational EM coincides with EM when q(H)=p(H|θ), in which case C(θ) is decreased at every iteration. In other cases, variational EM conducts approximate inference. The validity depends on how well q(H) approximates the true posterior probability p(H|θ).

Derivation of the Bound

The expressions of log p(V|WH) and log p(H|A) show that the coefficients of H are coupled through ratios or logarithms of linear combinations Σₖw_{fk}hₖₙ and Σⱼaᵢⱼhⱼ₍ₙ₋₁₎. This makes expectations of log p(V|WH) and log p(H|A) very difficult to determine independently of the specific form of q(H).

Therefore, we majorize log p(V|WH) and log p(H|A), to obtain a tractable bound. Using the above inequalities and assuming a factored form of the variational distribution, such that

$$q ( H ) = {\prod }_{kn} q ( {h}_{kn} )$$

is an upper bound of C(W,A,β), the function

$${B}_{q , ξ} ( W , A , β ) = {\sum }_{fkn} ( {φ}_{fkn}^{2} \frac{{v}_{fn}}{{w}_{fk}} 〈 {h}_{kn}^{- 1} 〉 + \frac{{w}_{fk}}{{ψ}_{fn}} 〈 {h}_{kn} 〉 ) + {\sum }_{fn} ( log {ψ}_{fn} - 1 ) + {\sum }_{n = 2}^{N} {\sum }_{i = 1}^{K} ( \begin{matrix}( 1 - {α}_{i} ) 〈 log {h}_{i n} 〉 + \\ {\sum }_{j = 1}^{K} ( \begin{matrix}{α}_{i} \frac{{a}_{ij}}{{ρ}_{i n}} 〈 {h}_{j ( n - 1 )} 〉 + \\ {β}_{i} \frac{{v}_{ijn}^{2}}{{a}_{ij}} 〈 {h}_{i n} 〉 〈 {h}_{j ( n - 1 )}^{- 1} 〉\end{matrix} )\end{matrix} ) + {\sum }_{n = 2}^{N} {\sum }_{i = 1}^{K} {α}_{i} ( log {ρ}_{i n} - 1 ) + ( N - 1 ) {\sum }_{i = 1}^{K} ( log Γ ( {α}_{i} ) - {α}_{i} log {β}_{i} ) + {\sum }_{i = 1}^{K} 〈 log {h}_{i 1} 〉 + {\sum }_{kn} 〈 log q ( {h}_{kn} ) 〉$$

Where φ_{fkn} are nonnegative coefficients such that Σₖφ_{fkn}=1,
vᵢⱼₙ are nonnegative coefficients such that Σᵢvᵢⱼₙ=1,
ρᵢₙ, ψ_{fn} are nonnegative coefficients,
ξ denotes the set of all tuning parameters {φ_{fkn}, vᵢⱼₙ, ρᵢₙ, ψ_{fn}}^{fknij}, [symbol]
• [symbol] denotes expectation w.r.t q, i.e., corresponds to [symbol] • [symbol] _{q}. We remove subscript q to alleviate notations.

The expression of the bound involves the expectation of hₖₙ, 1/hₖₙ and log hₖₙ. These expectations are precisely the sufficient statistics of the generalized inverse-Gaussian (GiG), which is a practical convenience for q(H). We use

$$q ( H ) = {\prod }_{kn} GIG ( {h}_{kn} \vert {\overline{α}}_{kn} , {\overline{β}}_{kn} , {\overline{γ}}_{kn} ) , \\ where$$

$$GIG ( x \vert α , β , γ ) = \frac{{( β / γ )}^{α / 2}}{2 {K}_{α} ( 2 \sqrt{βγ} )} {x}^{α - 1} exp - ( β x + \frac{γ}{x} ) ,$$

and where K_{α} is a modified Bessel function of the second kind and x, β and γ are nonnegative scalars. Under the GIG distribution,

$$\begin{matrix} 〈 x 〉 = \frac{{K}_{α + 1} ( 2 \sqrt{βγ} )}{{K}_{α} ( 2 \sqrt{βγ} )} \sqrt{\frac{γ}{β}} & ( 13 ) \\ {〈 {x}^{- 1} 〉}^{- 1} = \frac{{K}_{α} ( 2 \sqrt{βγ} )}{{K}_{α - 1} ( 2 \sqrt{βγ} )} \sqrt{\frac{γ}{β}} . & ( 14 )\end{matrix}$$

For any α, K_{α+1}(x)=2(α/x)K_{α}(x)+K_{α-1}(x), which leads to the alternative, implementation-efficient expression of

$$〈 {x}^{- 1} 〉 = \frac{{K}_{α + 1} ( 2 \sqrt{βγ} )}{{K}_{α} ( 2 \sqrt{βγ} )} \sqrt{\frac{β}{γ}} - \frac{α}{γ} . \qquad ( 15 )$$

Optimization of the Bound

We give the conditional updates of the various parameters of the bound. Update orders are described below.

Updates

Tuning parameters v

$$\begin{matrix}{φ}_{fkn} = \frac{{w}_{fk} {〈 {h}_{kn}^{- 1} 〉}^{- 1}}{{\sum }_{j} {w}_{fj} {〈 {h}_{jn}^{- 1} 〉}^{- 1}} , & ( 16 ) \\ {ψ}_{fn} = {\sum }_{j} {w}_{fj} 〈 {h}_{jn} 〉 , & ( 17 ) \\ {v}_{ijn} = \frac{{a}_{ij} {〈 {h}_{j ( n - 1 )}^{- 1} 〉}^{- 1}}{{\sum }_{k} {a}_{ik} {〈 {h}_{k ( n - 1 )}^{- 1} 〉}^{- 1}} , \\ and & ( 18 ) \\ {ρ}_{i n} = {\sum }_{j} {a}_{ij} 〈 {h}_{j ( n - 1 )} 〉 & ( 19 )\end{matrix}$$

Variational distribution q

n = 1

| | |
|---|---|
| α̅ₖₙ | 0 (Jeffreys) or 1 (uniform) |
| β̅ₖₙ | ${Σ}_{f} \frac{{w}_{fk}}{{ψ}_{fn}} + {Σ}_{i} {α}_{i} \frac{{a}_{ik}}{{ρ}_{i ( n + 1 )}}$ |
| γ̅ₖₙ | ${Σ}_{f} {φ}_{fkn}^{2} \frac{{v}_{fn}}{{w}_{fk}} + {Σ}_{i} {β}_{i} \frac{{v}_{ik ( n + 1 )}^{2}}{{a}_{ik}} 〈 {h}_{i ( n + 1 )} 〉$ |

1 < n < N

| | |
|---|---|
| α̅ₖₙ | αₖ |
| β̅ₖₙ | ${Σ}_{f} \frac{{w}_{fk}}{{ψ}_{fn}} + {Σ}_{i} {α}_{i} \frac{{a}_{ik}}{{ρ}_{i ( n + 1 )}} + {β}_{k} {Σ}_{j} \frac{{v}_{kjn}^{2}}{{a}_{kj}} 〈 {h}_{j ( n - 1 )}^{- 1} 〉$ |
| γ̅ₖₙ | ${Σ}_{f} {φ}_{fkn}^{2} \frac{{v}_{fn}}{{w}_{fk}} + {Σ}_{i} {β}_{i} \frac{{v}_{ik ( n + 1 )}^{2}}{{a}_{ik}} 〈 {h}_{i ( n + 1 )} 〉$ |

n = N

| | |
|---|---|
| α̅ₖₙ | αₖ |
| β̅ₖₙ | ${Σ}_{f} \frac{{w}_{fk}}{{ψ}_{fn}} + {β}_{k} {Σ}_{j} \frac{{v}_{kjn}^{2}}{{a}_{kj}} 〈 {h}_{j ( n - 1 )}^{- 1} 〉$ |
| γ̅ₖₙ | ${Σ}_{f} {φ}_{fkn}^{2} \frac{{v}_{fn}}{{w}_{fk}}$ |

Parameters of Interest

$$\begin{matrix}{w}_{fk} = \sqrt{\frac{{\sum }_{n = 1}^{N} {φ}_{fkn}^{2} {v}_{fn} 〈 {h}_{kn}^{- 1} 〉}{{\sum }_{n = 1}^{N} {ψ}_{fn}^{- 1} 〈 {h}_{kn} 〉}} & ( 20 ) \\ {a}_{ij} \sqrt{\frac{{β}_{i} {\sum }_{n = 2}^{N} {v}_{ijn}^{2} 〈 {h}_{i n} 〉 〈 {h}_{j ( n - 1 )}^{- 1} 〉}{{α}_{i} {\sum }_{n = 2}^{N} {ρ}_{i n}^{- 1} 〈 {h}_{j ( n - 1 )} 〉}} & ( 21 ) \\ {β}_{i} = {α}_{i} ( N - 1 ) {( {\sum }_{n = 2}^{N} \frac{〈 {h}_{i n} 〉}{{\sum }_{j} {a}_{ij} {〈 {h}_{j ( n - 1 )}^{- 1} 〉}^{- 1}} )}^{- 1} & ( 22 )\end{matrix}$$

Updating Order

We denote the set of tuning parameter for frame n by ξₙ, i.e., ξₙ{{φ_{fkn}}_{fk},{vᵢⱼₙ}ᵢⱼ,{ρᵢₙ}ᵢ,{ψ_{fn}}_{f}}.

As shown in FIG. 2, the following order of updates 230 leads to an efficient implementation.

At iteration (l) do

For n=1, . . . , N,

Update 231 the activation parameters [q(hₙ)]^{(l)} as a function of [q(hₙ₋₁)]^{(l)}, [q(hₙ)]^{(l-1)}, [q(hₙ₊₁)]^{(l-1)}, ξₙ^{(2l-2)}, W^{(l-1)}, A^{(l-1)}, β^{(l-1)}.

Update ξₙ^{(2l-1)}.

Update 232 the basis function W^{(l)} as a function of W^{(l-1)}, [q(H)]^{(l)}, ξ^{(2l-1)}.
Update 233 the transition matrix A^{(l)} as a function of A^{(l-1)}, β^{(l-1)}, [q(H)]^{(l)}, ξ^{(2l-1)},
Update tuning parameters ξ^{(2l)}
Update 234 gamma distribution parameters β^{(l)} as a function of the transition matrix A^{(l)} and the activation parameters, [q(H)]^{(l)}.

Under this updating order, the VB-EM procedure is:

Update q(H).

n = 1

| | |
|---|---|
| α̅ₖₙ | 0 (Jeffreys) or 1 (uniform) |
| β̅ₖₙ | ${Σ}_{f} \frac{{w}_{fk}}{{Σ}_{j} {w}_{fj} 〈 {h}_{jn} 〉} + {Σ}_{i} {α}_{i} \frac{{a}_{ik}}{{Σ}_{j} {a}_{ij} 〈 {h}_{jn} 〉}$ |
| γ̅ₖₙ | ${〈 {h}_{kn}^{- 1} 〉}^{- 2} ( {Σ}_{f} {w}_{fk} \frac{{v}_{fn}}{{( {Σ}_{j} {w}_{fj} {〈 {h}_{jn}^{- 1} 〉}^{- 1} )}^{2}} + {Σ}_{i} {β}_{i} {a}_{ik} \frac{〈 {h}_{i ( n + 1 )} 〉}{{( {Σ}_{j} {a}_{ij} {〈 {h}_{jn}^{- 1} 〉}^{- 1} )}^{2}} )$ |

1 < n < N

| | |
|---|---|
| α̅ₖₙ | αₖ |
| β̅ₖₙ | ${Σ}_{f} \frac{{w}_{fk}}{{Σ}_{j} {w}_{fj} 〈 {h}_{jn} 〉} + {Σ}_{i} {α}_{i} \frac{{a}_{ik}}{{Σ}_{j} {a}_{ij} 〈 {h}_{jn} 〉} + \frac{{β}_{k}}{{Σ}_{j} {a}_{kj} {〈 {h}_{j ( n - 1 )}^{- 1} 〉}^{- 1}}$ |
| γ̅ₖₙ | ${〈 {h}_{kn}^{- 1} 〉}^{- 2} ( {Σ}_{f} {w}_{fk} \frac{{v}_{fn}}{{( {Σ}_{j} {w}_{fj} {〈 {h}_{jn}^{- 1} 〉}^{- 1} )}^{2}} + {Σ}_{i} {β}_{i} {a}_{ik} \frac{〈 {h}_{i ( n + 1 )} 〉}{{( {Σ}_{j} {a}_{ij} {〈 {h}_{jn}^{- 1} 〉}^{- 1} )}^{2}} )$ |

n = N

| | |
|---|---|
| α̅ₖₙ | αₖ |
| β̅ₖₙ | ${Σ}_{f} \frac{{w}_{fk}}{{Σ}_{j} {w}_{fj} 〈 {h}_{jn} 〉} + \frac{{β}_{k}}{{Σ}_{j} {a}_{kj} {〈 {h}_{j ( n - 1 )}^{- 1} 〉}^{- 1}}$ |
| γ̅ₖₙ | ${〈 {h}_{kn}^{- 1} 〉}^{- 2} {Σ}_{f} {w}_{fk} \frac{{v}_{fn}}{{( {Σ}_{j} {w}_{fj} {〈 {h}_{jn}^{- 1} 〉}^{- 1} )}^{2}}$ |

### Update W, A, β

$${w}_{fk} = {w}_{fk} \sqrt{\frac{{\sum }_{n = 1}^{N} {〈 {h}_{kn}^{- 1} 〉}^{- 1} {{v}_{fn} [ {\sum }_{j} {w}_{fj} {〈 {h}_{jn}^{- 1} 〉}^{- 1} ]}^{- 2}}{{\sum }_{n = 1}^{N} {〈 {h}_{kn} 〉 [ {\sum }_{j} {w}_{fj} 〈 {h}_{jn} 〉 ]}^{- 1}}}$$

$${a}_{ij} = {a}_{ij} \sqrt{\frac{{β}_{i} {\sum }_{n = 2}^{N} {〈 {h}_{j ( n - 1 )}^{- 1} 〉}^{- 1} {〈 {h}_{i n} 〉 [ {\sum }_{k} {a}_{ik} {〈 {h}_{k ( n - 1 )}^{- 1} 〉}^{- 1} ]}^{- 2}}{{α}_{i} {\sum }_{n = 2}^{N} {〈 {h}_{j ( n - 1 )}^{- 1} 〉 [ {\sum }_{k} {a}_{ik} 〈 {h}_{k ( n - 1 )} 〉 ]}^{- 1}}}$$

$${β}_{i} = {α}_{i} ( N - 1 ) {( {\sum }_{n = 2}^{N} \frac{〈 {h}_{i n} 〉}{{\sum }_{j} {a}_{ij} {〈 {h}_{j ( n - 1 )}^{- 1} 〉}^{- 1}} )}^{- 1}$$

### Determine the Bound

$${B}_{q , ξ} ( W , A , β ) = {\sum }_{fn} ( log {\sum }_{j} {w}_{fj} 〈 {h}_{jn} 〉 + \frac{{v}_{fn}}{{\sum }_{j} {w}_{fj} {〈 {h}_{jn}^{- 1} 〉}^{- 1}} ) + {\sum }_{n = 2}^{N} {\sum }_{i = 1}^{K} ( {α}_{i} log {\sum }_{j} {a}_{ij} 〈 {h}_{j ( n - 1 )} 〉 + {β}_{i} \frac{〈 {h}_{in} 〉}{{\sum }_{j} {a}_{ij} {〈 {h}_{j ( n - 1 )}^{- 1} 〉}^{- 1}} ) + ( N - 1 ) {\sum }_{i = 1}^{K} ( log Γ ( {α}_{i} ) - {α}_{i} log {β}_{i} ) - {\sum }_{n = 1}^{N} {\sum }_{i = 1}^{K} ( {\overline{α}}_{in} log \sqrt{\frac{{\overline{γ}}_{in}}{{\overline{β}}_{in}}} + log {K}_{α} ( 2 \sqrt{{\overline{β}}_{in} {\overline{γ}}_{in}} ) + {\overline{β}}_{in} 〈 {h}_{in} 〉 + {\overline{γ}}_{in} 〈 {h}_{in}^{- 1} 〉 ) - KN log 2$$

Speech Denoising with the Dynamic Model

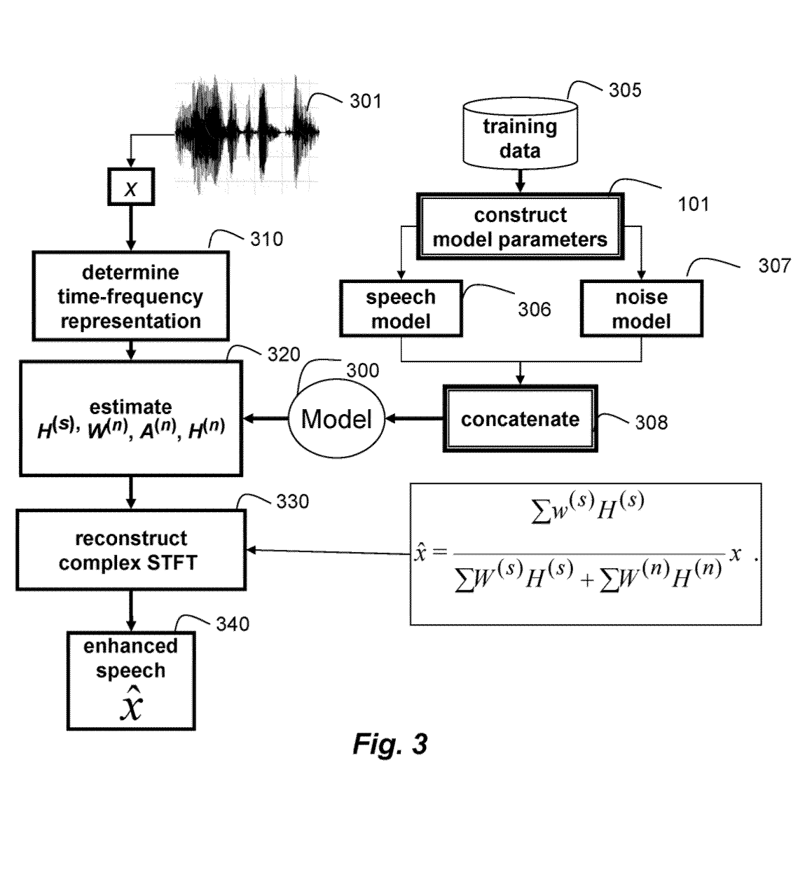

As shown in FIG. 3 for one embodiment, we use our method and model for speech enhancement, e.g., denoising. We construct our model parameters 101 for speech 306 by estimating bases W and the transition matrix A on some speech (audio) training data 305 as described above. We denote the trained bases and transition matrix as W^{(s)} and A^{(s)}, where (s) is speech.

Similarly, we construct a noise model 307 with bases W⁽ⁿ⁾ and transition matrix A⁽ⁿ⁾, and combining the two models 306-307 into the single model 300 by concatenating W^{(s)} and W⁽ⁿ⁾ into W=[W^{(s)},W⁽ⁿ⁾], and A^{(s)} and A⁽ⁿ⁾ into A, where A is a block-diagonal matrix with A^{(s)} and A⁽ⁿ⁾ on the diagonal.

We can also train for noise on some noise training data, or we can fix the speech part of the model, and train for the noise part on the test data, thus making the noise part a general model that collects parts of the signal that cannot be modeled by the speech model. The simplest version of the later model uses a single basis for the noise, and uses an identity matrix as the transition matrix A.

After the model 300 is constructed, we can use the model to enhance an input audio signal x 301. We determine 310 a time-frequency feature representation. We estimate 320 the parameters of the model 300 that vary, i.e., the activation matrix H^{(s)} for the speech and H⁽ⁿ⁾ for the noise (n), and the bases W⁽ⁿ⁾ and transition matrix A⁽ⁿ⁾ for the noise.

Thus, we obtain a single model that combines speech, W^{(s)}H^{(s)} and noise W⁽ⁿ⁾H⁽ⁿ⁾, which we then use to reconstruct 330 the complex STFT of the enhanced speech \hat{x} 340, using

$${\hat{x}}_{fn} = \frac{{\sum }_{k} {w}_{fk}^{( s )} {H}_{kn}^{( s )}}{{\sum }_{k} {W}_{fk}^{( s )} {H}_{kn}^{( s )} + {\sum }_{k} {W}_{fk}^{( n )} {H}_{kn}^{( n )}} {x}_{fn} . \qquad ( 23 )$$

The time-domain signal can be reconstructed using a conventional overlap-add method, which evaluates a discrete convolution of a very long input signal with a finite impulse response filter

Extensions

Other complex models can also generated based on the above embodiments.

Dirichlet Innovations

Instead of considering the innovation random variables εₙ to be gamma distributed, the innovation can be Dirichlet distributed, which is similar to a normalization of the activation parameter hₙ.

HMM-Like Behavior

We can constrain hₙ to be 1-sparse during inference.

Structured Variational Inference

Conventional variational inference assumes that the variational posterior probabilities q(hₙ) are independent of each other, which, given a strong dependency relation between hₙ and hₙ₋₁, is likely to be very wrong. We can model the posterior probability in terms of q(hₙ|hₙ₋₁). One possibility for such a q distribution uses a GIG distribution with parameters dependent on Ahₙ₋₁.

Gamma Distribution of Innovation

The complex Gaussian model on the complex STFT coefficients in Eqn. (6) is equivalent to assuming that the power is exponentially distributed with parameter WH. We can extend the model by assuming that the power is gamma distributed, thus leading to a donut-shaped distribution for the complex coefficients.

Full Covariance of Innovation Random Variables

In linear dynamical systems, the innovation random variables can have a full-covariance. For positive random variables, one way to include the correlations is to transform an independent random vector with a non-negative matrix. This leads to the model,

hₙ=(Ahₙ₋₁)∘(Bfₙ),

where fₙ is a nonnegative random vector of size J×1 and B is a nonnegative matrix of dimension K×J. When B=I_{K×K}, this simplifies to fₙ=εₙ. This can be accomplished in the more general form of the model

$${h}_{i , n} = {\sum }_{j , l} {c}_{i , j , l} {ɛ}_{l , n} {h}_{j , n - 1}$$

by setting the parameters to a factorized form: c_{i,j,l}=a_{i,j}b_{i,l}, where a_{i,j} are the elements of A, and b_{i,j} are the elements of B.

Transition Innovations

It can also be useful to model the transition between each of the components of hₙ and hₙ₋₁ using separate innovation random variables. This is analogous to the use of Dirichlet prior probabilities in discrete Markov models. One method would admit hₙ=(A∘Eₙ)hₙ₋₁, where Eₙ is a nonnegative innovations matrix of dimension K×K. This can be accomplished in the more general form of the model

$${h}_{i , n} = {\sum }_{j , l} {c}_{i , j , l} {ɛ}_{l , n} {h}_{j , n - 1}$$

by setting the parameters c_{i,j,l}=δ(m(i,j),l)a_{i,j}, where a_{i,j} are the elements of A and m(i,j) is a one-to-one mapping from each combination of i and j to an index corresponding to l. Then, the i, j-th element of Eₙ is ε_{m(i,j),n}.

Considering Other Innovation Types Besides Gam Ma

A log-normal, Poisson distribution leads to yet different types of dynamical systems.

Considering Other Divergences

We so far only considered the Itakura-Saito divergence. We can also use the KL-divergence, and different divergences for hₙ|hₙ₋₁ and for v|h.

Online Procedure

For real-time applications, only the signal up to the current time is used, e.g., an application where only the activation matrix H are estimated, or another application where all parameters are optimized. In the later application, we can perform a “warm” start with pretrained bases W and transition matrix A.

Multi-Channel Version

Because our model relies on a generative model involving the complex STFT coefficients, the model can be extended to a multi-channel application. Optimization in this setting involves EM updates between mixing system and a source NMF procedure.

### EFFECT OF THE INVENTION

The embodiments of the invention provide a non-negative linear dynamical system model for processing non-stationary signals, particularly speech signals mixed with noise. In the context of speech separation and speech denoising, our model adapts to signal dynamics on-line, and achieves better performance than conventional methods.

Conventional models for signal dynamics frequently use hidden Markov models (HMMs) or non-negative matrix factorization (NMF). HMMs lead to combinatorial problems due to the discrete state space, are computationally complex, especially for mixed signals from several sources, and make it difficult to handle gain adaptation. NMF solves both the computational complexity and gain adaptation problems. However, NMF does not take advantage of past observations of a signal to model future observations of that signal. For signals with predictable dynamics, this is likely to be suboptimal.

Our model has advantages of both the HMMs and the NMF. The model is characterized by a continuous non-negative state space. Gain adaptation is automatically handled during inference. The complexity of the inference is linear in the number of sources, and dynamics are modeled via a linear transition matrix.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A method for transforming an input signal, comprising the steps of:
storing parameters of a model of the input signal in a memory;
receiving the input signal as a sequence of feature vectors;
inferring, using the sequence of feature vectors and the parameters, a sequence of vectors of hidden variables, wherein there is at least one vector hₙ of hidden variables h_{i,n} for each feature vector xₙ, and wherein each hidden variable is nonnegative;
generating an output signal corresponding to the input signal, using the feature vectors, the vectors of hidden variables, and the parameters,
wherein each feature vector xₙ is dependent on at least one of the hidden variables h_{i,n} for the same n, and the hidden variables are related according to
$${h}_{i , n} = {\sum }_{j , l} {c}_{i , j , l} {ɛ}_{l , n} {h}_{j , n - 1} ,$$
where j and l are summation indices, the parameters include non-negative weights c_{i,j,l}, and ε_{l,n} are independent non-negative random variables, wherein the steps are performed in a processor.

2. The method of claim 1, wherein c_{i,j,l}=δ(i,l)a_{i,j}, where a_{i,j} are non-negative scalars, and where δ is a Kronecker delta, so that
$${h}_{i , n} = ( {\sum }_{j} {a}_{i , j} {h}_{j , n - 1} ) {ɛ}_{i , n} .$$

3. The method of claim 1, wherein c_{i,j,l}=δ(m(i,j),l)a_{i,j}, where a_{i,j} are non-negative scalars, δ is a Kronecker delta and, m(i,j) is a one-to-one mapping from each combination of i and j to an index corresponding to l, so that
$${h}_{i , n} = {\sum }_{j} {a}_{i , j} {ɛ}_{m} ( i , j ) , {n}^{h} j , n - 1.$$

4. The method of claim 1, wherein the random variables ε_{l,n} are gamma distributed.

5. The method of claim 1, wherein an observation model used during the inferring is based at least in part on
$${v}_{f , n} = {\sum }_{j} {c}_{f , i , l}^{( v )} {h}_{i , n} {ɛ}_{l , n}^{( v )} ,$$
where c_{f,i,l}^{(v)} is a non-negative scalar, and ε_{l,n}^{(v)} are independent non-negative random variables, v_{f,n} is a non-negative feature of the input signal at a frame n and feature f and j, and l are indices.

6. The method of claim 5, wherein c_{f,i,l}^{(v)}=δ(i,l)w_{f,j}, where w_{f,j} are non-negative scalars, where δ is a Kronecker delta, and ε_{f,n}^{(v)} are Gamma distributed random variables, so that the observation model based at least in part on
$$p ( {v}_{f , n} \vert {h}_{n} ) = Gamma ( {v}_{f , n} \vert {α}^{( v )} , {β}^{( v )} / {\sum }_{i} {w}_{f , i} {h}_{i , n} ) ,$$
where v_{f,n} is a non-negative feature of the input signal at frame n, f is frequency, Gamma(.|a,b) is a gamma distribution with shape parameter a and inverse-scale parameter b, α^{(v)} and β^{(v)} are positive scalars, and w_{f,i} are non-negative scalars.

7. The method of claim 5, further comprising:
obtaining the feature vectors x_{f,n} as a complex spectrogram of the input signal, where x_{f,n} is a value of the complex spectrogram for a frame n and frequency f, and
determining a non-negative feature v_{f,n}=|x_{f,n}|² as a power in frame n and frequency f so that the observation model is based at least in part on
$${x}_{f , n} = ( {e}^{{θ}_{f , n} \sqrt{- 1}} ) \sqrt{{v}_{f , n}} ,$$
where \sqrt{−1} is a unit imaginary number, and θ_{f,n} is a random variable representing a phase for the frame n and the frequency f.

8. The method of claim 6, further comprising:
setting the parameter α^{(v)}=1, and where θ_{f,n} is a uniformly distributed random phase variable, so that
$$p ( {x}_{f , n} \vert {h}_{n} ) = {N}_{c} ( 0 , {\sum }_{i} {w}_{f , i} {h}_{i , n} ) .$$
where N_{C} is a complex Gaussian distribution.

9. The method of claim 1, wherein the inferring uses a maximum a-posteriori estimation.

10. The method of claim 1, wherein the inferring uses a variational Bayes method.

11. The method of claim 1, wherein the inferring is adaptive and performed on-line on the input signal.

12. The method of claim 1, wherein the input signal is received simultaneously multiple channels.

13. The method of claim 1, wherein an observation model used during the inferring is based at least in part on
$${u}_{{i}^{′} , n} = {\sum }_{i} {c}_{{i}^{′} , i , l}^{( u )} {h}_{i , n} {ɛ}_{{l}^{′} , n}^{( u )} , \\ and$$
$${v}_{f , n} = {\sum }_{{i}^{′}} {c}_{f , {i}^{′} , l}^{( v )} {u}_{{i}^{′} , n} {ɛ}_{{l}^{″} , n}^{( v )} , \\ where$$
$${c}_{{i}^{′} , i , {l}^{′}}^{( u )}$$
$$and$$
$${c}_{f , {i}^{′} , {l}^{″}}^{( v )}$$
are non-negative scalars, and ε_{l′,n}^{(u)} and ε_{l″,n}^{(v)} are independent non-negative random variables, and i, i′, l′, l″, f, and n are indices.

14. The method claim 1, where the hidden variables h_{i,n} are partitioned into S groups, and the non-negative random variables ε_{l,n} are each associated with one of the groups, wherein c_{i,j,l}=0 when h_{i,n}, and h_{j,n}, or h_{i,n} and ε_{l,n} are in different groups.

15. The method of claim 1, wherein the model is dynamic, and the input signal is non-stationary.

16. The method of claim 1, further comprising:
adapting to again of the input signal on-line during the inferring.

17. The method of claim 1, wherein the input signal is a mixed signal of speech and noise, and the output signal is an enhanced speech signal.

18. The method of claim 1, wherein the parameters include basis functions W, a transition matrix A, an activation matrix H, a fixed shape parameter α, an inverse scale parameter β of a continuous gamma distribution parameter, and various combinations thereof.

19. The method of claim 18 wherein updating H and β are optional.

20. The method of claim 18, wherein updating β is optional in a maximum a-posteriori estimation used by the inferring.

21. The method of claim 1, wherein the input signal is received simultaneously from multiple sources by a single sensor.

22. The method of claim 18, wherein a posterior distribution of H is used in a variational Bayes method.
